(19) United States
(12) Patent Application Publication
(10) Pub. No.: US 2009/0118903 A1
(43) Pub. Date: May 7, 2009

(54) VEHICLE INFORMATION RECORD DEVICE, VEHICLE INFORMATION COLLECTION DEVICE, AND VEHICLE INFORMATION RECORD-COLLECTION SYSTEM

(75) Inventors: Motonori Kimura, Toyota -shi (JP); Hideaki Otsubo, Nishikamo-gun (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/258,770

(22) Filed: Oct. 27, 2008

(30) Foreign Application Priority Data
Nov. 6, 2007 (JP) 2007-288297

(51) Int. Cl. G06F 19/00

(52) U.S. Cl. 701/36

(57) ABSTRACT

A vehicle information record-collection system includes a plurality of drive recorders, and a center system. The center system sends setting change request information that includes vehicle information designated to be a record object to the drive recorder of each investigation object vehicle through wireless communication. The drive recorder of each vehicle, upon receiving the setting change request information from the center system through wireless communication, changes the setting of the vehicle information in terms of the record object on the basis of the setting change request information. After the setting change in terms of the record object, the drive recorder records the vehicle information, and sends the recorded vehicle information to the center system through wireless communication.

### INCORPORATION BY REFERENCE

The disclosure of Japanese Patent Application No. 2007-288297 filed on Nov. 6, 2007 including the specification, drawings and abstract is incorporated herein by reference in its entirety.

### BACKGROUND OF THE INVENTION

1. Field of Invention

The invention relates to a vehicle information record device that records vehicle information acquired in a vehicle, a vehicle information collection device that collects the vehicle information from the vehicle information record device, and a vehicle information record-collection system that includes these devices.

2. Description of Related Art

The vehicle information recorded by a vehicle information record device, such as a drive recorder or the like, is used to diagnose a failure that has occurred to the vehicle or to find out the cause of an accident. The drive recorders of recent years are able to record various kinds of vehicle information, including operation information regarding the brake, the steering handle, the transmission, etc., information from various sensors and the like that is input to ECUs, image information that is taken by a vehicle-mounted camera, etc. (see, e.g., Japanese Patent Application Publication No. 2007-157113 (JP-A-2007-157113), and Japanese Patent Application Publication No. 2004-46449 (JP-A-2004-46449)). The vehicle information recorded in the drive recorder is read by a dealer or a vehicle manager by using a dedicated terminal device.

A drive recorder described in Japanese Patent Application Publication No. 2007-157113 (JP-A-2007-157113) is able to transfer vehicle information from the vehicle to a center through wireless communication, so that the vehicle information can be collected at the center side. The vehicle information collected at the dealer or the center is later passed to the automaker, and then is analyzed.

The recording of vehicle information by the drive recorder is performed within the range allowed by the storage capacity of the drive recorder. Therefore, the automaker selects vehicle information items as record objects, and performs the setting of the drive recorder so that only the selected vehicle information items are recorded. After a vehicle is shipped from a factory, the aforementioned setting of the drive recorder can be changed by using a dedicated terminal device that is disposed at a dealer or the like.

However, the vehicle information that the automaker needs varies occasionally due to the occurrence of a fault or the like in the vehicle after the shipment, and it sometimes happens that the vehicle information items set as record objects in the initial setting made at the time of shipment from the factory are not the same as the vehicle information items that the automaker later needs. In such a case, there occurs a problem of being unable to record or collect the vehicle information that the automaker needs until after the vehicle is taken into the dealer or the like and the record object settings are changed through a dedicated terminal device. Particularly, in the case of the analysis of a fault of low reproducibility, it is necessary to have a large number of vehicles as investigation objects, and it takes a long period of time before the number of vehicles taken into dealers and the like reaches such a large number, thus giving rise to a risk of it becoming difficult to quickly find out the cause of the foregoing fault or the like.

### SUMMARY OF THE INVENTION

The invention provides a vehicle information record device, a vehicle information collection device, and a vehicle information record-collection system in which it is possible to quickly change the setting of record objects in a vehicle information record device (drive recorder) and quickly collect recorded vehicle information.

A vehicle information record device in accordance with a first aspect of the invention includes: setting storage means for storing a setting of vehicle information in terms of a record object; vehicle information record means for recording the vehicle information set as a record object; setting change request receiving means for receiving, through wireless communication, setting change request information that requests that the setting of the vehicle information in terms of the record object be changed; and setting change means for changing, when the setting change request information is received, the setting of the vehicle information in terms of the record object based on the setting change request information.

The vehicle information record device as described above receives through wireless communication the setting change request information sent from a predetermined sender device (e.g., a vehicle information collection device), and changes the setting of the vehicle information in terms of the record object on the basis of the setting change request information. Hence, the change of the setting of record objects in the vehicle information record device can be quickly performed by remote operation from the aforementioned predetermined sender device, independently of the times at which the vehicles are taken into the dealers, the present positions of the vehicles, the circumstances of the users of the vehicles, etc. Therefore, even in the case where the vehicle information that the automaker needs does not match the record objects of the vehicle information record device set according to the initial setting (or the present setting) due to occurrence of a fault or the like in the vehicle after the shipment thereof from the automaker factory, or the like, the setting in the vehicle information record device can be immediately changed so as to start the recording of the vehicle information that the automaker needs, by sending the setting change request information from the predetermined sender device to the vehicle information record device through wireless communication.

A vehicle information record device in accordance with a second aspect of the invention includes: setting storage means for storing a setting of a recording period of vehicle information set as a record object; vehicle information record means for recording the vehicle information set as the record object for the set recording period; setting change request receiving means for receiving, through wireless communication, setting change request information that requests that the setting of the recording period of the vehicle information set as the record object be changed; setting change means for changing, when the setting change request information is received, the setting of the recording period of the vehicle information set as the record object based on the setting change request information.

The vehicle information record device described above receives through wireless communication the setting change request information sent from a predetermined sender device (e.g., a vehicle information collection device), and changes the setting of the recording period of the vehicle information on the basis of the setting change request information. Therefore, for example, by changing the setting of the recording period to a period of a minimum length, the burden on the storage resource of the vehicle information record device can be lessened.

A vehicle information record device in accordance with a third aspect of the invention includes: setting storage means for storing a setting of vehicle information in terms of a record object, and a setting of a recording period of the vehicle information; vehicle information record means for recording the vehicle information set as the record object for the set recording period; setting change request receiving means for receiving, through wireless communication, setting change request information that requests the setting of the vehicle information in terms of the record object and the setting of the recording period of the vehicle information be changed; and setting change means for changing, when the setting change request information is received, the setting of the vehicle information in terms of the record object and the setting of the recording period of the vehicle information based on the setting change request information.

The vehicle information record device described above receives through wireless communication the setting change request information sent from a predetermined sender device (e.g., a vehicle information collection device), and changes the setting of the vehicle information in terms of the record object and the setting of the recording period of the vehicle information set as the record object on the basis of the setting change request information. Therefore, this device achieves substantially the same operation and effect as the vehicle information record devices in accordance with the first aspect and the second aspect.

A vehicle information collection device in accordance with a fourth aspect of the invention includes: designation means for designating the vehicle information that needs to be a record object at a vehicle information record device of an investigation object vehicle; and setting change request sending means for sending, through wireless communication, setting change request information that includes the vehicle information designated to be the record object by the designation means to the vehicle information record device of the investigation object vehicle.

The vehicle information collection device described above sends the setting change request information that includes the vehicle information that needs to be a record object, to the vehicle information record device that is installed in each of investigation object vehicles, through wireless communication. Hence, if the vehicle information record device that is the destination receives the setting change request information through wireless communication, and changes the setting of the vehicle information in terms of the record object on the basis of the setting change request information, the change of the setting of the record objects in the vehicle information record device can be quickly performed by remote operation from the vehicle information collection device side, independently of the number of the vehicles (the vehicle information record devices), the times at which the vehicles are taken into the dealers, the present positions of the vehicles, the circumstances of the users of the vehicles, etc. Therefore, even in the case where the vehicle information that the automaker needs does not match the record objects of a vehicle information record device set according to the initial setting (or the present setting) due to occurrence of a fault or the like in the vehicle after the shipment thereof from the automaker factory, the recording of the vehicle information that the automaker needs can be immediately started, by sending the setting change request information from the vehicle information collection device to the vehicle information record device through wireless communication.

A vehicle information collection device in accordance with a fifth aspect of the invention includes: designation means for designating a recording period of vehicle information that a vehicle information record device of an investigation object vehicle records; and setting change request sending means for sending, through wireless communication, setting change request information that includes the recording period designated by the designation means to the vehicle information record device of the investigation object vehicle.

The vehicle information collection device described above sends through wireless communication the setting change request information that includes the recording period of the vehicle information to be recorded to the vehicle information record device of the investigation object vehicle. Therefore, if the vehicle information record device that is the destination receives the setting change request information through wireless communication, and changes the setting of the recording period of the vehicle information on the basis of the setting change request information, the change of the setting of the recording period of the vehicle information can be quickly performed by remote operation from the vehicle information collection device side, independently of the number of the vehicles (the vehicle information record devices), the times at which the vehicles are taken into the dealers, the present positions of the vehicles, the circumstances of the users of the vehicles, etc. Furthermore, by changing the setting of the recording period to a period of a minimum length, the burden on the storage resource of the vehicle information record device can be lessened.

A vehicle information collection device in accordance with a sixth aspect of the invention includes: designation means for designating vehicle information that needs to be a record object at a vehicle information record device of an investigation object vehicle, and a recording period of the vehicle information; and setting change request sending means for sending, through wireless communication, setting change request information that includes the vehicle information designated to be the record object by the designation means, and the recording period of the vehicle information that is also designated by the designation means, to the vehicle information record device of the investigation object vehicle.

The vehicle information collection device described above sends through wireless communication the setting change request information that includes the vehicle information that needs to be a record object and the recording period of that vehicle information to the vehicle information record device of the investigation object vehicle. Therefore, this device achieves substantially the same operation and effects as the foregoing vehicle information record devices in accordance with the fourth and fifth aspects.

A vehicle information record-collection system in accordance with a seventh aspect of the invention is a vehicle information record-collection system that includes a vehicle information collection device and a vehicle information record device. The vehicle information collection device includes: designation means for designating the vehicle information that needs to be a record object at the vehicle information record device of an investigation object vehicle; and setting change request sending means for sending, by wireless communication, setting change request information that includes the vehicle information designated to be the record object by the designation means to the vehicle information record device of the investigation object vehicle. On the other hand, the vehicle information record device includes: setting storage means for storing a setting of the vehicle information in terms of the record object; vehicle information record means for recording the vehicle information set as the record object; setting change request receiving means for receiving, through wireless communication, setting change request information from the vehicle information collection device; and setting change means for changing, when the setting change request information is received, the setting of the vehicle information in terms of the record object based on the setting change request information.

According to the vehicle information record-collection system described above, as the setting change request information is sent from the vehicle information collection device to one or more vehicle information record devices through wireless communication, the setting of the vehicle information in terms of the record object in each vehicle information record device is changed. Hence, the change of the setting can be quickly performed by remote operation independently of the number of the vehicles (the vehicle information record devices), the times at which the vehicles are taken into the dealers, the present positions of the vehicles, the circumstances of the users of the vehicles, etc. Even in the case where the vehicle information that the automaker needs does not match the record objects of the vehicle information record device of an investigation object vehicle set according to the initial setting (or the present setting) due to, for example, occurrence of a fault or the like in the vehicle after the shipment thereof from the automaker factory, or the like, the setting in the vehicle information record device can be immediately changed so as to start the recording of the vehicle information that the automaker needs, by sending the setting change request information from the vehicle information collection device to the vehicle information record device through wireless communication.

A vehicle information record-collection system in accordance with an eighth aspect of the invention is a vehicle information record-collection system that includes a vehicle information collection device and a vehicle information record device. The vehicle information collection device includes: designation means for designating a recording period of vehicle information that the vehicle information record device of an investigation object vehicle records; and setting change request sending means for sending, through wireless communication, setting change request information that includes the recording period designated by the designation means to the vehicle information record device of the investigation object vehicle. The vehicle information record device includes: setting storage means for storing a setting of the vehicle information in terms of a record object, and a setting of a recording period of the vehicle information; vehicle information record means for recording the vehicle information set as the record object for the set recording period; setting change request receiving means for receiving, through wireless communication, the setting change request information from the vehicle information collection device; and setting change means for changing, when the setting change request information is received, the setting of the recording period of the vehicle information set as the record object based on the setting change request information.

According to the vehicle information record-collection system described above, the setting change request information is sent from the vehicle information collection device to the vehicle information record device through wireless communication, and the vehicle information record device changes the setting of the recording period of the vehicle information on the basis of the setting change request information. Hence, for example, the vehicle information record device can be caused to record the vehicle information for a period of a minimum length, so that the burden on the storage resource of the vehicle information record device side can be lessened.

A vehicle information record-collection system in accordance with a ninth aspect of the invention is a vehicle information record-collection system that includes a vehicle information collection device and a vehicle information record device. The vehicle information collection device includes: designation means for designating vehicle information that needs to be a record object at the vehicle information record device of an investigation object vehicle, and a recording period of the vehicle information; and setting change request sending means for sending, through wireless communication, setting change request information that includes the vehicle information designated to be the record object by the designation means, and the recording period of the vehicle information that is also designated by the designation means, to the vehicle information record device of the investigation object vehicle. On the other hand, the vehicle information record device includes: setting storage means for storing a setting of the vehicle information in terms of the record object, and a setting of a recording period of the vehicle information; vehicle information recording means for recording the vehicle information set as the record object for the set recording period; setting change request receiving means for receiving, through wireless communication, the setting change request information from the vehicle information collection device; and setting change means for changing, when the setting change request information is received, the setting of the vehicle information in terms of the record object and the setting of the recording period of the vehicle information based on the setting change request information.

According to the vehicle information record-collection system described above, the setting change request information is sent from the vehicle information collection device to the vehicle information record device through wireless communication, and the vehicle information record device changes the setting of the vehicle information in terms of the record object and the setting of the recording period of the vehicle information on the basis of the setting change request information. Therefore, this system achieves substantially the same operation and effects as the foregoing vehicle information record-collection systems in accordance with the seventh and eighth aspects.

According to the invention, the change of the setting of the vehicle information record device in terms of the record object and the collection of the recorded vehicle information can be quickly performed.

### BRIEF DESCRIPTION OF THE DRAWINGS

The foregoing and further objects, features and advantages of the invention will become apparent from the following description of exemplary embodiments with reference to the accompanying drawings, wherein like numerals are used to represent like elements and wherein:

FIG. 1 is a system construction diagram showing a general construction of a vehicle information record-collection system in accordance with an embodiment of the invention;

FIGS. 2A and 2B are diagrams showing examples of a setting table belonging to a drive recorder (vehicle information record device) in which record objects of vehicle information, and the like are set, FIG. 2A and FIG. 2B showing states of the setting table before and after, respectively, the setting is changed;

FIG. 3 shows an example of a registered information database belonging to a center system (vehicle information collection device) in which the state of the setting of the drive recorder of each vehicle, and the like are registered; and

FIG. 4 is a flowchart showing a processing procedure that is executed by the drive recorder (vehicle information record device) and the center system (vehicle information collection device).

### DETAILED DESCRIPTION OF EMBODIMENTS

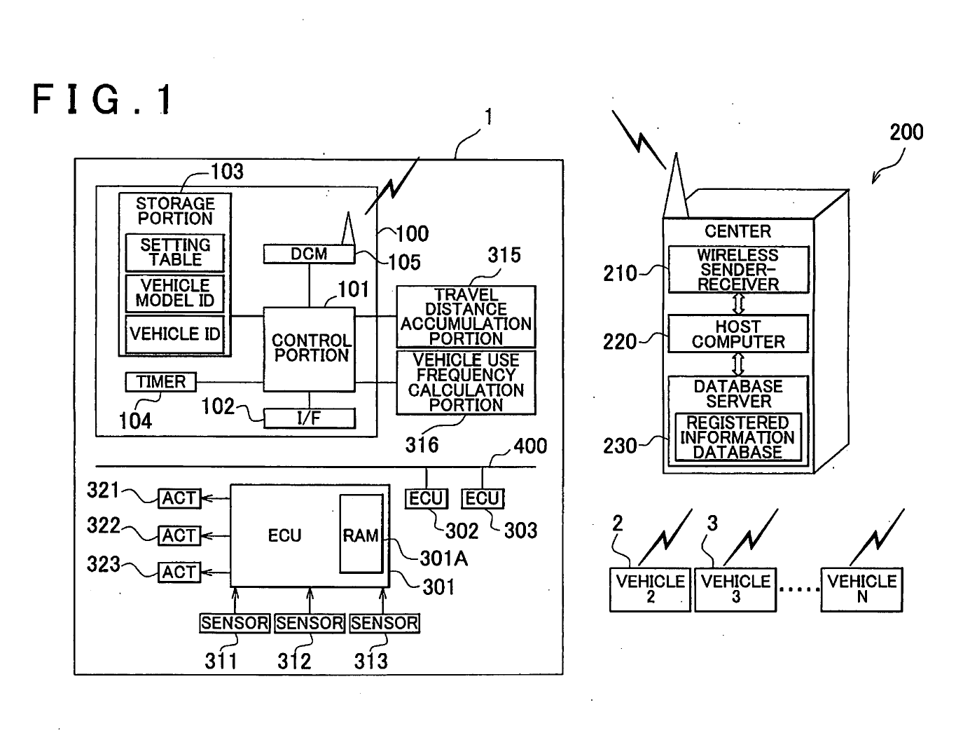

Hereinafter, embodiments of the invention will be described with reference to the drawings. FIG. 1 shows an example of a construction of a vehicle information record-collection system in accordance with the embodiment of the invention. The vehicle information record-collection system is constructed of drive recorders 100 that are installed as vehicle information record devices in individual vehicles 1, 2, 3, . . . , N, a center system 200 that is installed as a vehicle information collection device at an information center, and other components. The drive recorder 100 installed in each vehicle 1, 2, 3, . . . , N and the center system 200 include wireless communication means capable of mutual communication.

The drive recorder 100 installed in each vehicle 1, 2, 3, . . . , N includes a control portion 101 made up of a CPU, a ROM, a RAM, etc. (which are not shown), and also includes an interface 102, a storage portion 103, a timer 104, a DCM (data communication-module) 105, etc.

The control portion 101 controls the various portions by following control programs pre-stored in the ROM. For example, the control portion 101 accesses RAMs 301A of ECUs (electronic control units) 301 to 303 (RAMs of the ECUs 302, 303 are not shown), and acquires various kinds of vehicle information that are input to the ECUs 301 to 303. In the ROM of the control portion 101, address information for use for writing various kinds of vehicle information into the RAMs of the ECUs 301 to 303 is registered beforehand. Using the address information as a guide, the control portion 101 reads necessary vehicle information from the RAMs of the ECUs 301 to 303. Besides, a travel distance accumulation portion 315 that accumulates the vehicle travel distance, and a vehicle use frequency calculation portion 316 that calculates the frequency of use of the vehicle are connected to the control portion 101. From these portions 315, 316, the vehicle travel distance information and the vehicle use frequency information are input to the control portion 101. In addition, the vehicle use frequency calculation portion 316 calculates the number of days in a fixed period (e.g., one month) on which the vehicle is used, and outputs results of the calculation to the control portion 101. The use of the vehicle can be detected using sensors or the like by monitoring portions or sites that are operated when a user uses the vehicle, such as the portions or sites related to the starting-up of the engine, the opening or closing movement of a door, etc. For example, the vehicle use frequency calculation portion 316 can be constructed by an electronic circuit that calculates the number of days on which the operation of an operating portion or site as mentioned above is detected by a sensor or the like.

Incidentally, the vehicle information is information that can be acquired and recorded at a vehicle, and is not limited to the vehicle information presented as an example in conjunction with this embodiment.

The interface 102 is a communication interface between the drive recorder 100 and the ECUs 301 to 303 of the vehicle. The interface 102 adopted in this embodiment is a LAN (local area network) interface.

In the storage portion 103, the vehicle information that the control portion 101 reads from the ECUs 301 to 303 is recorded. Therefore, the storage portion 103 adopted herein is non-volatile storage means, for example, an F-ROM (flash ROM), an HDD (hard disk drive), etc.

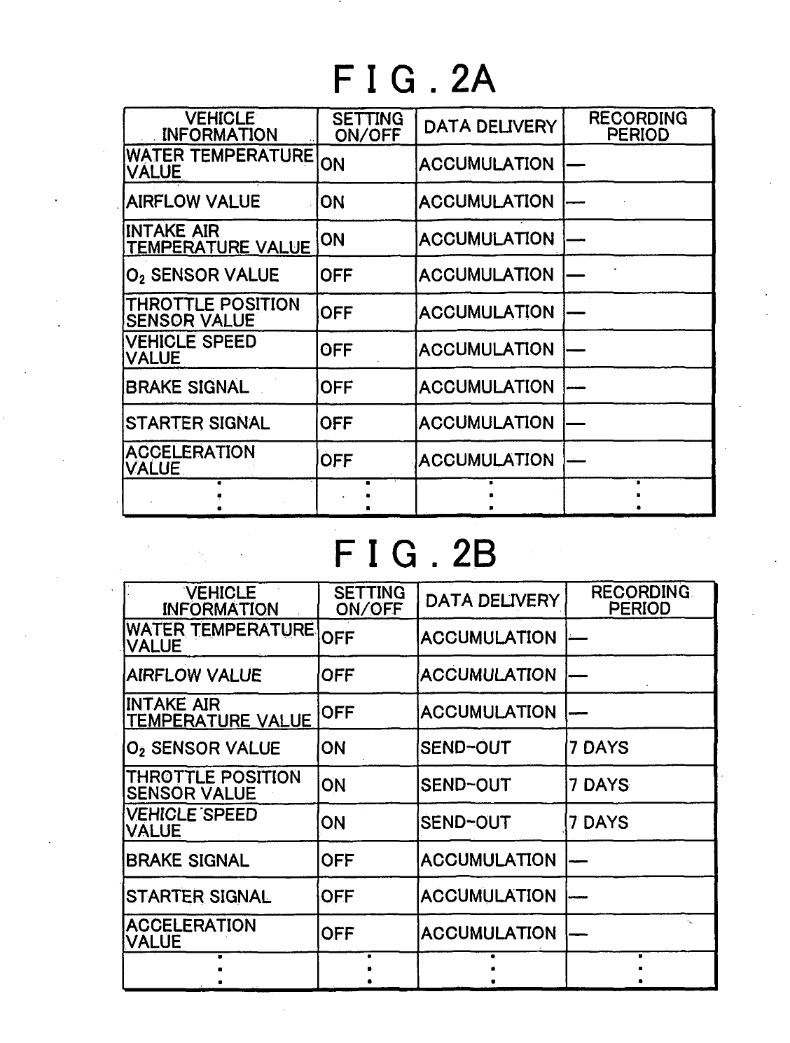

The storage portion 103 stores beforehand a setting table that contains the settings of vehicle information items as record objects and of the recording period of the vehicle information items, as shown in FIGS. 2A and 2B. This setting table is constructed so that the setting of a record object, the setting of a data delivery method, the setting of a recording period can be stored separately for each item of vehicle information. The setting of a record object includes the “ON” setting in which an item of vehicle information is set as a record object, and the “OFF” setting in which a vehicle information item is set as a non-record object. This setting can be made separately for each item of vehicle information. The setting of the data delivery method includes the “ACCUMULATION” setting in which recorded data of a vehicle information item set as a record object is accumulated, and the “SEND-OUT” setting in which recorded data of a vehicle information item is sent out to the center system 200 side through wireless communication at the elapse of the set recording period described below. Besides, the setting of a recording period determines a period of time from the start of recording the vehicle information of an item set as a record object till the end of recording the vehicle information.

Besides, the storage portion 103 stores information such as the vehicle identification, the vehicle model identification, the manufacture date (not shown), the manufacture factory (not shown), etc., of the host vehicle.

The timer 104 is time measurement means, and starts a time measurement process upon a time measurement start command from the control portion 101, and, after that, outputs the elapsed time from the start of the time measurement process in response to an inquiry from the control portion 101.

The DCM 105 is a data communication module for performing wireless communication with the center system 200. The DCM 105 sends to the center system 200 the vehicle information, the communication control information, etc. that is passed from the control portion 101, and receives the information sent from the center system 200 and passes the received information to the control portion 101.

Incidentally, although not shown in the drawings, the drive recorder 100 is provided with a connection port for a dedicated terminal device that is disposed at a dealer or the like. Therefore, by connecting such a dedicated terminal device to the connection port, the vehicle information recorded and accumulated in the storage portion 103 of the drive recorder 100 can be transferred to the dedicated terminal device side. The dedicated terminal device is a known technology for those with ordinary skill in the art, and is omitted from the description herein.

In each of the vehicles 1, 2, 3, . . . , N, the drive recorder 100 and the ECUs 301 to 303 are interconnected for communication via a LAN 400. The ECUs 301 to 303 are an engine ECU, a transmission ECU, a safety device ECU, or the like, and each of the ECUs is constructed mainly of a computer that includes a CPU, a ROM, a RAM, etc. (which are not shown in the drawings). For example, the ECU 301 controls the movements of actuators 321, 322, 323, etc. on the basis of the vehicle information input from various sensors and the like 311, 312, 313, etc. Although not shown in the drawings, the ECUs 302, 303 likewise controls the movements of actuators and the like on the basis of the vehicle information input from various sensors and the like.

The center system 200 is constructed of a wireless sender-receiver 210, a host computer 220, a database server 230, etc.

The wireless sender-receiver 210 performs wireless communication with the drive recorder 100 that is installed in each of the vehicles 1, 2, 3, . . . , N to send to and receive from the drive recorder 100 thereof various kinds of information that are output to and input from the host computer 220.

The host computer 220 includes a computation process portion capable of high-speed computation processing, an output portion, such as a display or the like, and an input portion such as a keyboard or the like. By operating the input portion in a predetermined fashion, it is possible to edit the database in the database server 230 or register new information into the database from the host computer 220.

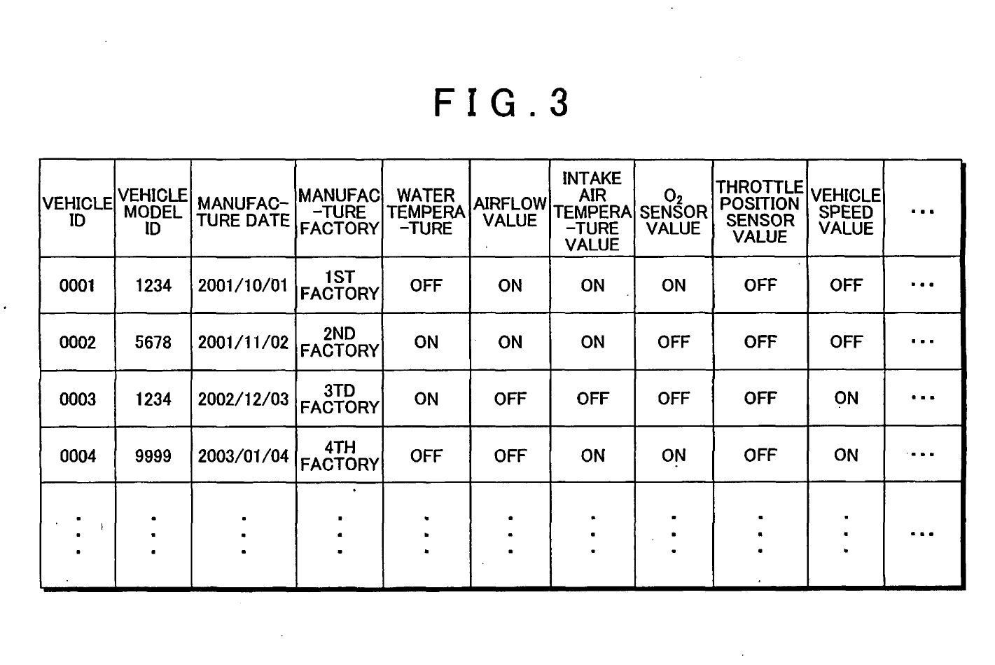

As shown in FIG. 3, in a registered information database provided in the database server 230, the record object settings of vehicle information items in various drive recorders 100 and the vehicle identifications of the vehicles in each of which the drive recorder 100 is installed are registered in such a manner that the settings and the vehicle identifications are associated with each other in correspondence. What are registered with each registered vehicle identification further include the vehicle model identification, the date of manufacture of the vehicle, and the manufacture factory of the vehicle that are associated in correspondence with the vehicle identification. It suffices that the vehicle identification be information that is unique to the vehicle so as to allow the vehicle to be identified. The vehicle identification may be a frame number of the vehicle, or an identification information piece that is allotted to the drive recorder, or the like. Besides, the vehicle model identification may be an identification information piece that identifies the entire vehicle, such as the name of the vehicle or the like, or an identification information piece that identifies a portion of the vehicle, for example, the chassis type, the engine type, the transmission type, the suspension type, etc.

When a vehicle is shipped from an automaker's factory, information regarding the shipped vehicle (the vehicle identification, the vehicle model identification, the manufacture date, the manufacture factory, the record object settings of various vehicle information items, etc.) is registered in the registered information database provided in the database server 230, via a terminal device (not shown) capable of accessing the host computer 220 or the database server 230.

Next, description will be made regarding a process operation that is executed by the drive recorder 100 installed in each of the vehicles 1, 2, 3, . . . , N and by the center system 200 in the case where the center system 200 changes the record object settings of vehicle information items in the drive recorder 100 of each vehicle 1, 2, 3, . . . , N, and collects the vehicle information that is recorded by the drive recorder 100 of each vehicle after the change of the settings.

Firstly, prior to the execution of the process operations of the drive recorder 100 and the center system 200, a person in charge at the automaker, or the like, determines the condition for selecting vehicles that need to be included as investigation object vehicles according to the purpose of the investigation (to find out the cause of a fault or the like that has occurred in the vehicle, or to find out the cause of an accident, etc.). This selection condition is, for example, the vehicle identification, the vehicle model identification, the manufacture date, the manufacture factory, the frequency of use of the vehicle, the travel distance of the vehicle, etc. In addition, the kinds of vehicle information to be acquired from the investigation object vehicle are also determined.

If the number of investigation object vehicles is small, the person in charge at the automaker, or the like, can access the database server 230, and can designate the selection condition (the vehicle identification, the vehicle model identification, the manufacture date, the manufacture factory, etc.) that matches the investigation object vehicles, and can check the present record object settings of vehicle information items in the drive recorder 100 of each of the vehicles that meet the selection condition. In the case where the aforementioned settings in the drive recorder 100 of a checked vehicle do not need to be changed and vehicle information does not need to be immediately collected, there is no need to change the record object settings of vehicle information items. That is, the collection of the vehicle information recorded in the drive recorder 100 can wait until the vehicle is taken into a dealer or the like, where the vehicle information is collected.

On the other hand, in the case where there is a need to change the record object settings of vehicle information items in the drive recorder 100 of an investigation object vehicle, or in the case where there is a need to collect vehicle information in a short period of time, a predetermined operation for changing the settings is performed by the center system 200.

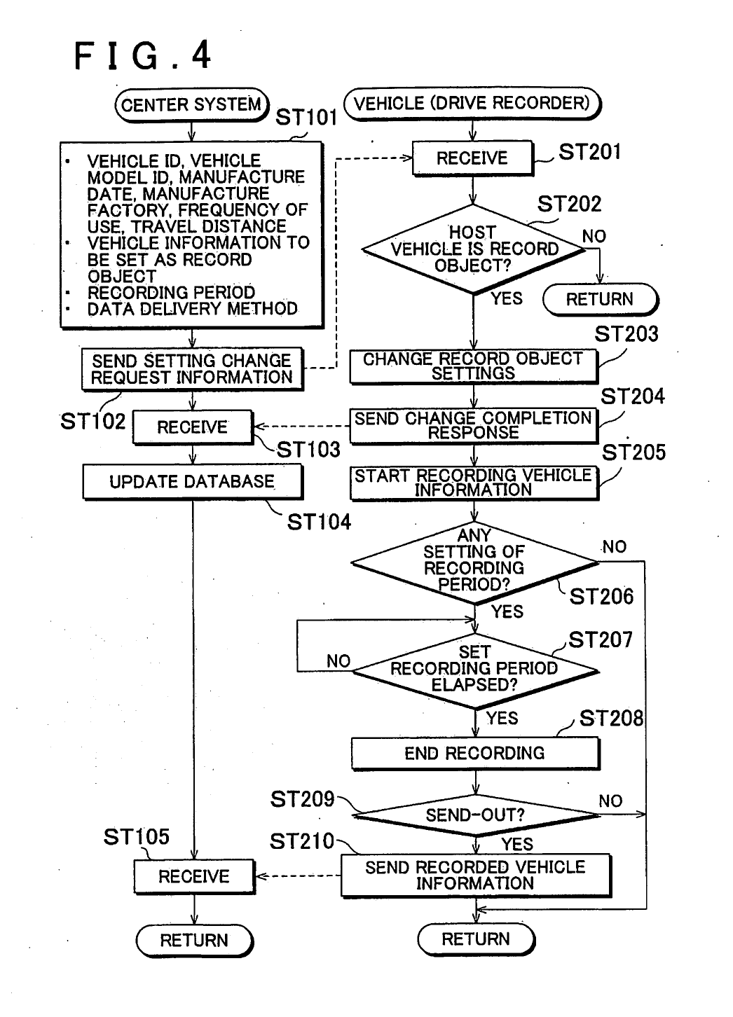

The process operation executed by the center system 200 and drive recorders 100 in this case will be described below with reference to the flowchart shown in FIG. 4. Incidentally, in the flowchart shown in FIG. 4, the procedure performed in the center system 200 and the procedure performed in a drive recorder are shown in correspondence in order to facilitate the understanding of the illustration and description. However, in reality, the center system 200 executes the process operations shown in step ST103 and the subsequent steps in the flowchart, with a plurality of drive recorders 100.

In step ST101, the vehicle identification, the vehicle model identification, the manufacture date, the manufacture factory, the frequency of use of the vehicle (e.g., the minimum number of days of use per month), the travel distance (e.g., a travel distance range of 0 to 1500 km, of greater than or equal to 50000 km, etc.) are input and designated in the host computer 220, as selection conditions for selecting investigation object vehicles. The number of values of each of the items that are input and designated may be one or more. Besides, the number of items input and designated may also be one or more.

Furthermore, the vehicle information items that the drive recorder 100 of each investigation object vehicle needs to set as record objects, the recording periods of the record-object vehicle information items, the data delivery methods for the recorded vehicle information items, etc. are input and designated in the host computer 220 of the center system 200. Herein, the designation of the recording period is performed on the basis of, for example, time information such as one day, one week, one month, etc. Besides, as for the data delivery method, either the “ACCUMULATION” setting in which the send-out of vehicle information recorded is not required or the “SEND-OUT” setting in which the send-out of vehicle information recorded is required is designated.

In step ST102, the host computer 220 sends setting change request information that includes the vehicle information items to be set as record objects, the recording periods thereof, and the data delivery methods therefore, and that requests the corresponding changes in the setting, simultaneously to the drive recorders 100 of the vehicles 1, 2, 3, . . . , N, via the wireless sender-receiver 210 on the basis of the selection conditions set in step ST101. Instead, in the case where the number of investigation object vehicles is small, the host computer 220 may send the setting change request information to each of the small number of investigation object vehicles on a one-to-one basis after the one-to-one communication connection status therewith has been established.

In step ST201, the drive recorder 100 of each of the vehicles 1, 2, 3, . . . , N receives the selection conditions and the setting change request information from the center system 200 side, via the DCM 105.

In step ST202, the control portion 101 of the drive recorder 100 of each vehicle 1, 2, 3, . . . , N analyzes the selection conditions received, and determines whether or not the host vehicle satisfies the designated selection conditions, such as the vehicle identification, the vehicle model identification, the manufacture date, the manufacture factory, the frequency of use of the vehicle, the travel distance, etc. In the case where there are a plurality of selection conditions, the control portion 101 determines whether or not the host vehicle satisfies all the selection conditions. For example, in the case where the vehicle identification, the vehicle model identification, the manufacture date and the manufacture factory are designated as selection conditions, the control portion 101 determines whether or not the vehicle identification, the vehicle model identification, the manufacture date and the manufacture factory designated as the selection conditions match the vehicle identification, the vehicle model identification, the manufacture date and the manufacture factory of the host vehicle stored beforehand in the storage portion 103 or the like. In the case where the frequency of use of the vehicle is designated as a selection condition, the control portion 101 acquires the frequency-of-use information from the vehicle use frequency calculation portion 316, and checks the information against the received frequency of use, and determines whether or not the frequency of use acquired from the vehicle use frequency calculation portion 316 satisfies the received frequency of use. Besides, in the case where the travel distance is designated as a selection condition, the control portion 101 acquires the travel distance from the travel distance accumulation portion 315, and checks it against the received travel distance, and determines whether or not the travel distance acquired from the travel distance accumulation portion 315 satisfies the received travel distance.

In the case where the result of the determination is that the host vehicle satisfies the selection conditions, the process proceeds to the next step. In the case where it is determined that the host vehicle does not satisfy the selection conditions, the control portion 101 exits the routine of this flowchart. That is, in step ST202, the control portion 101 of the drive recorder 100 of each of the vehicles 1, 2, 3, . . . , N meets the setting change request only when the host vehicle satisfies the selection conditions.

In step ST203, the control portion 101 of the drive recorder 100 changes settings in the setting table (e.g., see FIG. 2A) stored in the storage portion 103, on the basis of the received setting change request information. That is, the control portion 101 executes a setting change in which the vehicle information items that need to be set as record objects included in the setting change request information received in step ST201 are set as “ON” in the setting table, and the vehicle information items that are not included in the setting change request information are set as “OFF” in the setting table. Besides, the control portion 101 also performs a setting change in which the recording period included in the setting change request information is set as the period of recording the vehicle information. Furthermore, the control portion 101 performs a setting change in which the data delivery method included in the setting change request information is set as the delivery method for the vehicle information in the setting table. Incidentally, if a setting in the drive recorder 100 prior to the reception of the setting change request information is the same as the corresponding setting that is included in the setting change request information, the setting regarding that information item in the drive recorder 100 is not changed but maintained.

With reference to FIGS. 2A and 2B, examples of the setting change executed by the control portion 101 of the drive recorder 100 will be described. In the case where the setting change request information received by the control portion 101 of the drive recorder 100 includes the “O₂ sensor value”, the “throttle position sensor value”, and the “vehicle speed” as the vehicle information items that need to be record objects, and includes the “SEND-OUT” as the data delivery method, and includes the “7 days” as the recording period, the setting table is changed from the state shown in FIG. 2A to the state shown in FIG. 2B. Specifically, upon receiving the setting change request information, the control portion 101 of the drive recorder 100 changes the settings of the “water temperature”, the “airflow value” and the “intake air temperature sensor” from the “ON” setting to the “OFF” setting, and changes the settings of the “O₂ sensor value”, the “throttle position sensor value”, and the “vehicle speed” from the “OFF” setting to the “ON” setting. Besides, the control portion 101 changes the setting of the data delivery method for the “O₂ sensor value”, the throttle position sensor value” and the “vehicle speed” from an unset state to the “SEND-OUT” setting, and changes the setting of the recording periods thereof from an unset state to the “7 days”.

In step ST204, the control portion 101 of the drive recorder 100 sends a change completion response to the center system 200 through wireless communication via the DCM 105. The sending of the change completion response is executed in order to notify the center system 200 side that the record object settings of vehicle information items and the like have been completed as requested. In addition, together with the change completion response, the control portion 101 sends further information, including the vehicle model identification, the vehicle identification, the date of completion of the setting change, etc., to the center system 200 side.

On the other hand, in step ST103, the host computer 220 of the center system 200 receives the change completion response from the drive recorder 100 through wireless communication via the sender-receiver 210.

In step ST104, the host computer 220 of the center system 200 accesses the database server 230, and changes the record object settings of the vehicle information items that have been registered in the registered information database in the database server 230 (see FIG. 3) in correspondence to the vehicle identification of the vehicle that is the sender of the change completion response, on the basis of the setting change request information sent in step S102. That is, the settings in the vehicle information record device 100 installed in the sender vehicle of the change completion response and the settings associated in correspondence with the vehicle identification of that vehicle in the registered information database are made equal to each other.

In step ST205, the control portion 101 of the drive recorder 100 that has sent the change completion response starts recording the vehicle information items set as record objects. At this time, the control portion 101 refers to the address information for the writing-in of the vehicle information items with the “ON” setting in terms of the record object (the address information about each vehicle information item is pre-stored in the ROM of the control portion 101 or the like), and reads the corresponding vehicle information from the RAMs of the ECUs 301 to 303, and records the vehicle information in the storage portion 103. Besides starting the recording, the control portion 101 of the drive recorder 100 commands the timer 104 to start the time measurement process. Upon receiving this command, the timer 104 starts the time measurement process.

In step ST206, the control portion 101 of the drive recorder 100 determines whether or not the recording period has been set, on the basis of the settings in the setting table (FIG. 2B). In the case where the recording period has been set, the process proceeds to the next step. In the case where the recording period has not been set, that is, in the case where the “unset state” (“-” in FIGS. 2A and 2B) has been set, the control portion 101 exits the routine of this flowchart, and continues recording vehicle information. In addition, in the case where the recording period has not been set and the recording of the vehicle information is continuously performed, the control portion 101 overwrites the oldest vehicle information piece with the latest vehicle information piece when the data size of the vehicle information recorded in the storage portion 103 reaches a threshold value, in order to avoid the overflow of the capacity of the storage portion 103 with the recording of vehicle information.

In step ST207, the control portion 101 of the drive recorder 100 inquires of the timer 104 the elapsed time from the start of the measurement, and determines whether or not the recording period set in the setting table has elapsed, on the basis of the elapsed time obtained from the timer 104. In the case where it is determined that the set recording period has elapsed, the process proceeds to the next step. In the case where it is determined that the set recording period has not elapsed, the control portion 101 repeats the determination process of ST207.

In step ST208, the control portion 101 of the drive recorder 100 ends the recording of vehicle information that is started in step ST205.

In step ST209, the control portion 101 of the drive recorder 100 refers to the data delivery method that is set in correspondence with each vehicle information item set as a record object in the setting table, and determines whether the data delivery method is the “ACCUMULATION” setting or the “SEND-OUT” setting. In the case where it is determined that the data delivery method is of the “SEND-OUT” setting, the control portion 101 proceeds to the next step. In the case where it is determined that the data delivery method is of the “ACCUMULATION” setting, the control portion 101 exits the routine of the flowchart.

In step ST210, the control portion 101 of the drive recorder 100 reads the recorded vehicle information from the storage portion 103, and sends it to the center system 200 through wireless communication via the DCM 105. In addition to the recorded vehicle information, the control portion 101 also sends the information that indicates the kinds of the vehicle information pieces, the vehicle model identification, the vehicle identification, the recording period, etc.

On the other hand, the host computer of the center system 200, in step ST105, receives the vehicle information and the like recorded and sent by the drive recorder 100, through wireless communication via the wireless sender-receiver 210, and stores the received vehicle information together with the vehicle identification, the vehicle model identification, the recording period, etc., into a storage device (e.g., the storage device in the host computer). Later, the stored vehicle information and the like are passed to the automaker or the like that has requested the vehicle information.

In the case where a negative determination is made in ST206 or ST209, information recorded and accumulated in the drive recorder, such as the vehicle information and the like, is read together with the vehicle model identification, the vehicle identification, the recording period, etc., when the vehicle is taken into a dealer or the like. The read vehicle information and the like are passed to the center system 200 or an automaker that has requested the vehicle information.

The invention is applicable to a vehicle information record-collection system constructed of a drive recorder that records vehicle information, and a center system that collects information from the drive recorder through wireless communication.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

What is claimed is:

1. A vehicle information record device comprising:
a setting storage portion that stores a setting of vehicle information in terms of a record object;
a vehicle information record portion that records the vehicle information set as a record object;
a setting change request receiving portion that receives, through wireless communication, setting change request information that requests that the setting of the vehicle information in terms of the record object be changed; and
a setting change portion that changes, when the setting change request information is received, the setting of the vehicle information in terms of the record object based on the setting change request information.

2. The vehicle information record device according to claim 1, further comprising:
a vehicle information sending portion that sends, through wireless communication, the vehicle information-recorded by the vehicle information record portion.

3. The vehicle information record device according to claim 1, further comprising:
a response sending portion that sends a change completion response through wireless communication after the setting is changed by the setting change portion.

4. A vehicle information record device comprising:
a setting storage portion that stores a setting of a recording period of vehicle information set as a record object;
a vehicle information record portion that records the vehicle information set as the record object for the set recording period;
a setting change request receiving portion that receives, through wireless communication, setting change request information that requests that the setting of the recording period of the vehicle information set as the record object be changed;
a setting change portion that changes, when the setting change request information is received, the setting of the recording period of the vehicle information set as the record object based on the setting change request information.

5. The vehicle information record device according to claim 4, further comprising:
a vehicle information sending portion that sends, through wireless communication, the vehicle information recorded by the vehicle information record portion.

6. The vehicle information record device according to claim 4, further comprising:
a response sending portion that sends a change completion response through wireless communication after the setting is changed by the setting change portion.

7. A vehicle information record device comprising:
a setting storage portion that stores a setting of vehicle information in terms of a record object, and a setting of a recording period of the vehicle information;
a vehicle information record portion that records the vehicle information set as the record object for the set recording period;
a setting change request receiving portion that receives, through wireless communication, setting change request information that requests the setting of the vehicle information in terms of the record object and the setting of the recording period of the vehicle information be changed; and
a setting change portion that changes, when the setting change request information is received, the setting of the vehicle information in terms of the record object and the setting of the recording period of the vehicle information based on the setting change request information.

8. The vehicle information record device according to claim 7, further comprising:
a vehicle information sending portion that sends, through wireless communication, the vehicle information recorded by the vehicle information record portion.

9. The vehicle information record device according to claim 7, further comprising:
a response sending portion that sends a change completion response through wireless communication after the setting is changed by the setting change portion.

10. A vehicle information collection device comprising:
a designation portion that designates the vehicle information that needs to be a record object at a vehicle information record device of an investigation object vehicle; and
a setting change request sending portion that sends, through wireless communication, setting change request information that includes the vehicle information designated to be the record object by the designation portion to the vehicle information record device of the investigation object vehicle.

11. A vehicle information collection device comprising:
a designation portion that designates a recording period of vehicle information that a vehicle information record device of an investigation object vehicle records; and
a setting change request sending portion that sends, through wireless communication, setting change request information that includes the recording period designated by the designation portion to the vehicle information record device of the investigation object vehicle.

12. A vehicle information collection device comprising:
a designation portion that designates vehicle information that needs to be a record object at a vehicle information record device of an investigation object vehicle, and a recording period of the vehicle information; and
a setting change request sending portion that sends, through wireless communication, setting change request information that includes the vehicle information designated to be the record object by the designation portion, and the recording period of the vehicle information that is also designated by the designation portion, to the vehicle information record device of the investigation object vehicle.

13. The vehicle information collection device according to claim 10, further comprising:
a vehicle information receiving portion that receives, through wireless communication, the vehicle information recorded by the vehicle information record device and sent from the vehicle information record device.

14. The vehicle information collection device according to claim 10, further comprising:
a registration portion that registers a setting of the vehicle information in terms of the record object in the vehicle information record device and vehicle identification information so that the setting and the vehicle identification information are associated with each other in correspondence;
a response receiving portion that receives, through wireless communication, a change completion response sent from the vehicle information record device after the setting change request information is sent by the setting change request sending portion; and
a registration change portion that changes, after the change completion response is received by the response receiving portion, the setting of the vehicle information in terms of the record object that is registered associated in correspondence with the vehicle identification information of the investigation object vehicle that is a sender of the change completion response, based on the setting change request information that has been sent to the vehicle information record device.

15. A vehicle information record-collection system that includes a vehicle information collection device and a vehicle information record device, wherein:
the vehicle information collection device includes:
a designation portion that designates the vehicle information that needs to be a record object at the vehicle information record device of an investigation object vehicle; and
a setting change request sending portion that sends, by wireless communication, setting change request information that includes the vehicle information designated to be the record object by the designation portion to the vehicle information record device of the investigation object vehicle, and
and wherein the vehicle information record device includes:
a setting storage portion that stores a setting of the vehicle information in terms of the record object;
a vehicle information record portion that records the vehicle information set as the record object;
a setting change request receiving portion that receives, through wireless communication, setting change request information from the vehicle information collection device; and
a setting changed portion that changes, when the setting change request information is received, the setting of the vehicle information in terms of the record object based on the setting change request information.

16. A vehicle information record-collection system that includes a vehicle information collection device and a vehicle information record device, wherein:
the vehicle information collection device includes:
a designation portion that designates a recording period of vehicle information that the vehicle information record device of an investigation object vehicle records; and
a setting change request sending portion that sends, through wireless communication, setting change request information that includes the recording period designated by the designation portion to the vehicle information record device of the investigation object vehicle, and
and wherein the vehicle information record device includes:
a setting storage portion that stores a setting of the vehicle information in terms of a record object, and a setting of a recording period of the vehicle information;
a vehicle information record portion that records the vehicle information set as the record object for the set recording period;
a setting change request receiving portion that receives, through wireless communication, the setting change request information from the vehicle information collection device; and
a setting change portion that changes, when the setting change request information is received, the setting of the recording period of the vehicle information set as the record object based on the setting change request information.

17. A vehicle information record-collection system that includes a vehicle information collection device and a vehicle information record device, wherein the vehicle information collection device includes:
a designation portion that designates vehicle information that needs to be a record object at the vehicle information record device of an investigation object vehicle, and a recording period of the vehicle information; and
a setting change request sending portion that sends, through wireless communication, setting change request information that includes the vehicle information designated to be the record object by the designation portion, and the recording period of the vehicle information that is also designated by the designation portion, to the vehicle information record device of the investigation object vehicle, and
and wherein the vehicle information record device includes:
a setting storage portion that stores a setting of the vehicle information in terms of the record object, and a setting of a recording period of the vehicle information;
a vehicle information record portion that records the vehicle information set as the record object for the set recording period;
a setting change request receiving portion that receives, through wireless communication, the setting change request information from the vehicle information collection device; and
a setting change portion that changes, when the setting change request information is received, the setting of the vehicle information in terms of the record object and the setting of the recording period of the vehicle information based on the setting change request information.

18. The vehicle information record-collection system according to claim 15,
wherein the vehicle information record device further includes a vehicle information sending portion that sends, through wireless communication, the vehicle information recorded by the vehicle information record portion to the vehicle information collection device, and
wherein the vehicle information collection device further includes a vehicle information receiving portion that receives, through wireless communication, the vehicle information recorded and sent by the vehicle information record device.

19. The vehicle information record-collection system according to claim 15,
wherein the vehicle information record device further includes a response sending portion that sends a change completion response to the vehicle information collection device through wireless communication after the setting change request information is received by the setting change request receiving portion and the setting is changed by the setting change portion, and
wherein the vehicle information collection device further includes:
a registration portion that registers the setting of the vehicle information in terms of the record object in the vehicle information record device and vehicle identification information so that the setting and the vehicle identification information are associated with each other in correspondence;
a response receiving portion that receives, through wireless communication, the change completion response sent from the vehicle information record device after the setting change request information is sent by the setting change request sending portion; and
a registration change portion that changes, after the change completion response is received by the response receiving portion, the setting of the vehicle information in terms of the record object that is registered associated in correspondence with the vehicle identification information of the investigation object vehicle that is a sender of the change completion response, based on the setting change request information that has been sent to the vehicle information record device.
